(19) United States
(12) Patent Application Publication
(10) Pub. No.: US 2016/0247166 A1
(43) Pub. Date: Aug. 25, 2016

(54) EFFICIENT RECOVERY FOR ELECTRONIC DEVICES

(71) Applicant: Microsoft Technology Licensing, LLC, Redmond, WA (US)

(72) Inventor: Nicholas Bradley Tucker, Redmond, WA (US)

(21) Appl. No.: 14/630,962

(22) Filed: Feb. 25, 2015

(51) Int. Cl. G06Q 30/00

(52) U.S. Cl. CPC G06Q 30/016

(57) ABSTRACT

Embodiments are directed to efficiently recovering an electronic device. In one scenario, a computer system determines that a user's electronic device is in a lost or stolen state. The computer system sends a notification to the electronic device indicating multiple different methods of returning the electronic device to the electronic device's manufacturer. Upon receiving the electronic device, the computer system identifies the owner of the electronic device, determines how to provide the electronic device to the identified owner, and provides the electronic device to the identified owner in the determined manner.

### BACKGROUND

Smart phones, tablets and wearable devices have become highly popular in today's society. Many people own a smart phone, a tablet and/or multiple wearable devices. As these devices proliferate, more and more of them end up being misplaced, lost or stolen. Efficiently and effectively returning these devices to their owners has become problematic. Current methods typically provide a large amount of personal information to the finder of the device.

### BRIEF SUMMARY

Embodiments described herein are directed to multiple efficiently recovering an electronic device. In one embodiment, a computer system determines that a user's electronic device is in a lost or stolen state. The computer system sends a notification to the electronic device indicating multiple different methods of returning the electronic device to the electronic device's manufacturer. Upon receiving the electronic device, the computer system identifies the owner of the electronic device, determines how to provide the electronic device to the identified owner, and provides the electronic device to the identified owner in the determined manner. In this way, an electronic device can be returned to its owner in a secure manner that avoids exposing the owner's personal information to the finder. This process is also more reliable as the device is returned to the manufacturer which will have infrastructure in place to ensure that the device is returned to its proper owner.

In another embodiment, a computer system is implemented to efficiently recover an electronic device. The computer system determines that the electronic device has been reset. The computer system then queries an electronic device recovery service to determine whether the electronic device has been registered as lost or stolen and, upon determining that the electronic device has been registered as lost or stolen, the computer system provides an indication on the electronic device of how the electronic device can be returned to the electronic device's manufacturer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including efficiently recovering an electronic device.

FIG. 2 illustrates a flowchart of an example method for efficiently recovering an electronic device.

FIG. 3 illustrates a flowchart of an alternative example method for efficiently recovering an electronic device.

FIG. 4 illustrates an embodiment in which an electronic device is returned to its proper owner via one of four different routes.

FIG. 5 illustrates an embodiment in which an electronic device provides return instructions on its home screen.

### DETAILED DESCRIPTION

Embodiments described herein are directed to efficiently recovering an electronic device. In one embodiment, a computer system or an electronic device recovery service running on the computer system determines that a user's electronic device is in a lost or stolen state. The computer system sends a notification to the electronic device indicating multiple different methods of returning the electronic device to the electronic device's manufacturer. Upon receiving the electronic device, the computer system identifies the owner of the electronic device, determines how to provide the electronic device to the identified owner, and provides the electronic device to the identified owner in the determined manner. In this way, an electronic device can be returned to its owner in a secure manner that avoids exposing the owner's personal information to the finder. This process is also more reliable as the device is returned to the manufacturer which will have infrastructure in place to ensure that the device is returned to its proper owner

In another embodiment, a computer system is implemented to efficiently recover an electronic device. The computer system or an electronic device recovery service or other service running on the computer system determines that the electronic device has been reset. The computer system then queries an electronic device recovery service to determine whether the electronic device has been registered as lost or stolen and, upon determining that the electronic device has been registered as lost or stolen, the computer system provides an indication on the electronic device of how the electronic device can be returned to the electronic device's manufacturer.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

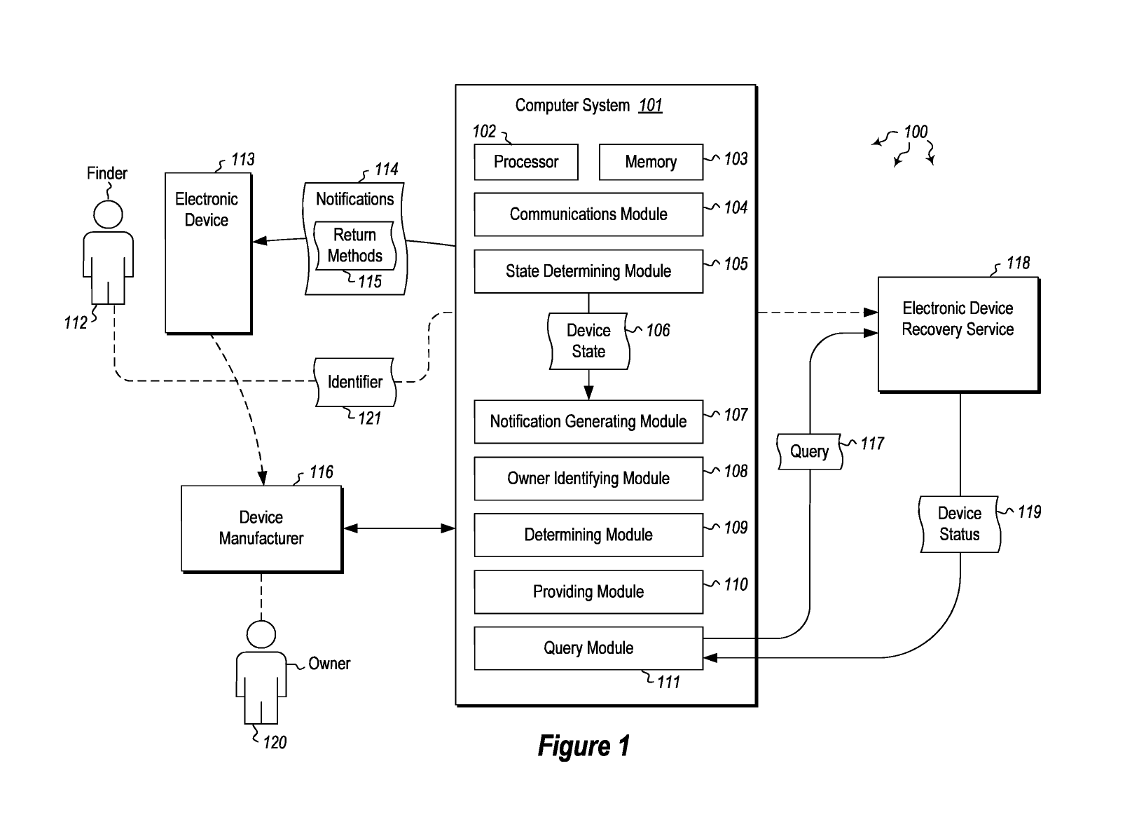

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems.

The communications module 104 may further be configured to receive data such as state data from electronic devices. For instance, electronic device 113 may send state data to communications module 104 of computer system 101 where the state data indicates which state the electronic device is currently in. The electronic device may, for example, be in a lost or stolen state. The owner of the device may contact the device manufacturer 116 to let them know that the device has gone missing. Upon determining that the device is in a lost or stolen state 106 (e.g. based on the owner's contact or based on some other indication), the notification generating module 107 of computer system 101 may generate a notification 114 and send the notification to the electronic device 113. The notification 114 may include an indication of one or more return methods 115 that are available to the device finder 112. These return methods may include a variety of choices, including sending the device to the device's manufacturer 116, taking the device to the post office and mailing it to a specified address, taking the device to a manufacturer's store (or to another specified store) or taking the device to another specified location which may perhaps be a location agreed upon by the device's owner.

Once the device is received at the device manufacturer 116, the owner identifying module 108 may identify the owner 120 of the device. The device manufacturer may maintain a listing of all of their devices sold and tie the serial number (or other identifier) of each device to a particular owner. Each owner may own many different devices. As such, in some embodiments, when the device manufacturer 116 determines that one of the owner's devices is in a lost or stolen state, the manufacturer can send a notification 114 to another of the owner's devices indicating the current status of the owner's lost or stolen device such as where it is, whether it has been wiped or not, whether it has been used for communications, whether applications or other items have been purchased or downloaded using the device, etc.

After the owner 120 of the device has been identified, the determining module 109 of computer system 101 determines the best manner to return the device to the owner. This may include sending the device to another location (e.g. a manufacturer's store) closer to where the owner lives, or sending the device in a postal package, or notifying the owner 120 via email or via some other means that the device has been located and is available for pickup. The providing module 110 may then ensure that the electronic device is provided to the rightful owner in the determined manner. Still further, in some embodiments, an electronic device recovery service may be used to help return the lost or stolen device to its rightful owner. The query module 111 of computer system 101 may be used to generate a query 117 that queries the electronic device recovery service 118 to determine the device's current reported status. The service 118 may perform a lookup to determine the device's status and, upon determining the status 119, may send it to the communications module 104 of computer system 101. Then, depending on the status 119 provided by the electronic device recovery service 118, the determining module 109 may determine the best way to return the device and the providing module 110 may provide the device to the owner 120 in the determined manner. If the electronic device status is lost or stolen, notification 114 including return methods 115 would be sent to the electronic device 113 and displayed on the device.

Thus, as described above, it may be relatively easy for a hardware device, especially a mobile device such as a smartphone, tablet, or wearable device, to be misplaced or stolen. Various anti-theft solutions provide mechanisms to protect data on a lost or stolen device and prevent it from being used by someone else. However these services only address data loss and do not address the return of the device to the owner 120. Solutions for device recovery are low-tech, insecure, and highly manual mechanisms that are generally ineffective in helping return the found device to the owner. Moreover, these mechanisms typically expose personal information about both parties. Some device recovery features allow owners to enter their email or phone numbers to show on the lost or stolen device's screen, while others may allow the owner to enter a custom message where they may enter personal information in the hopes of having the device returned.

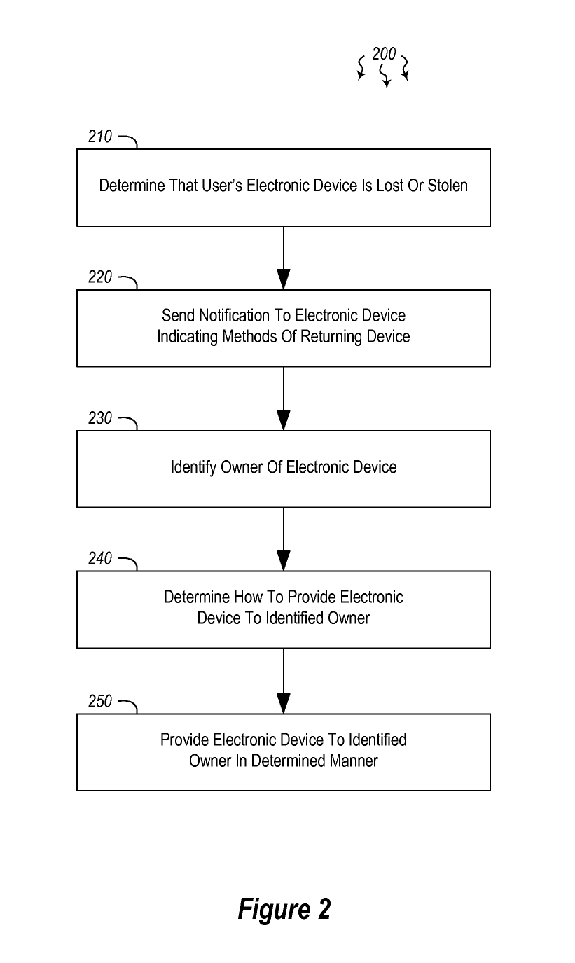

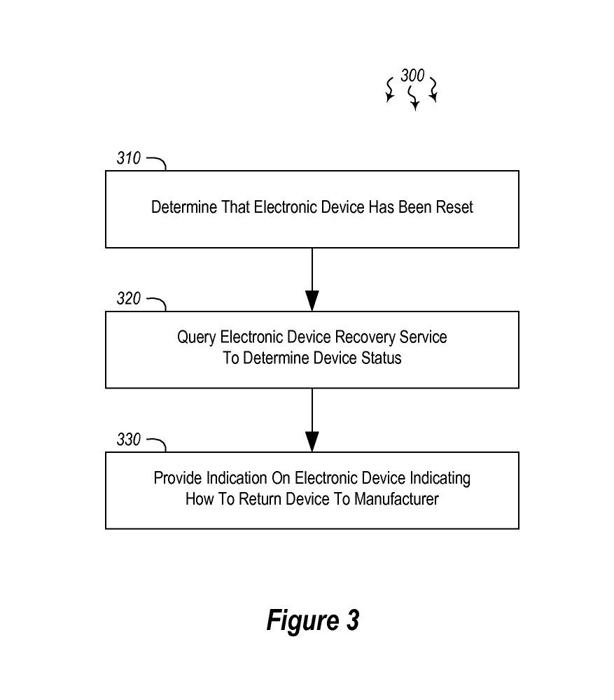

This embodiments provided herein describe multiple mechanisms for an individual that has possession of a lost or stolen device (e.g. an unknown person, law enforcement, device reseller, etc.) to return the device to the proper owner without putting the owner's or the returner's privacy at risk. Additionally, the owner or return processor can opt to provide a reward for the return once it has been successfully processed and verified. Using the embodiments described herein, the potential for device recovery and customer satisfaction increases by having a simple, secure, and potentially incentivized recovery process. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for efficiently recovering an electronic device. The method 200 will now be described with frequent reference to the components and data of environment 100.

Method 200 includes determining that a user's electronic device is in a lost or stolen state (210). For example, the state determining module 105 of computer system 101 may determine that electronic device 113 is in a lost or stolen state. The state determining module 105 may make this determination based on an indication from the device itself, or based on an indication from an outside source. For example, if an owner 120 reports their device as lost or stolen to the manufacturer 116 or to an electronic device recovery service 118, the manufacturer or recovery service may send a message to the device indicating that it has been stolen. The message may indicate to the device that it is to go into a locked mode that prevents users from using the device or making changes to the device. Still further, the message may indicate to the device that it is to wipe its existing data. Upon receiving such a message, the electronic device may be configured to display certain information on the display screen.

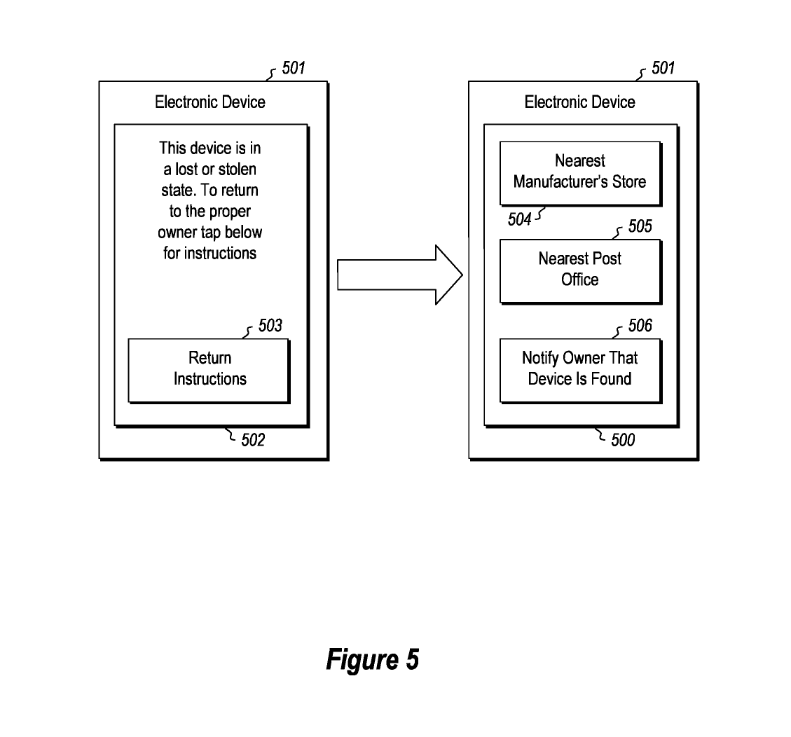

For example, as shown in FIG. 5, the electronic device 501 may display a message 502 such as the following: “This device is in a lost or stolen state. To return the device to the proper owner 120, tap below for instructions.” Of course, it will be understood that substantially any message or no message may be displayed on the electronic device's screen. In the example above, the display screen may display a “Return Instructions” button 503 or similar mechanism that allows a device finder to interact with the device and receive audio, video or textual instructions on how to return the device to the owner. Upon pressing the button 503, the electronic device 501 may display an indication of the device manufacture's nearest store 504, an indication of the nearest post office 505 so that the finder can mail the device to a specified address (such as the address of the device manufacturer 116), or a button providing some other location for return. Still further, the display screen may display a button 506 that notifies the owner that the device has been found. Alternatively, this feature may be implemented without displaying a button on the device. For instance, the device's screen could just say “Please return to Store Name at this address” where a valid store name and address are indicated. Either approach may be used to communicate what to do with a found device.

In some embodiments, if the finder or current possessor of the electronic device 501 selects the button that notifies the owner that the device has been found, a dialog may be opened between the finder and the owner. The dialog may take place over email, text message (e.g. SMS), phone or other means of communication. Using the dialog, the finder or possessor of the electronic device 501 may communicate with the true owner of the device to agree upon an acceptable method of returning the device. If the owner does not wish to give out personal details like their name, phone number, address or other information, the dialog may allow the owner to present information about a specified location at which to meet, or may indicate to the finder that they should mail the device to a given address, or that the finder should return the device to the nearest device manufacturer store. The finder or possessor may continue to communicate to the owner in this manner until the device has been relinquished to another entity.

In some cases, however, it should be noted that communication may be blocked by the recipient at any time. This provides anti-abuse functionality so that someone who has stolen or recovered an electronic device could be blocked by the owner from messaging them and harassing them. For example, the finder may have no intent to return the device, and may just use the messaging mechanism to taunt or extort the owner. Still further, in some cases, the notify owner button 506 simply sends a notification message to the owner that the device has been found. Subsequent messages may indicate that the device is being returned through proper channels, and may even provide an expected date of return to the owner.

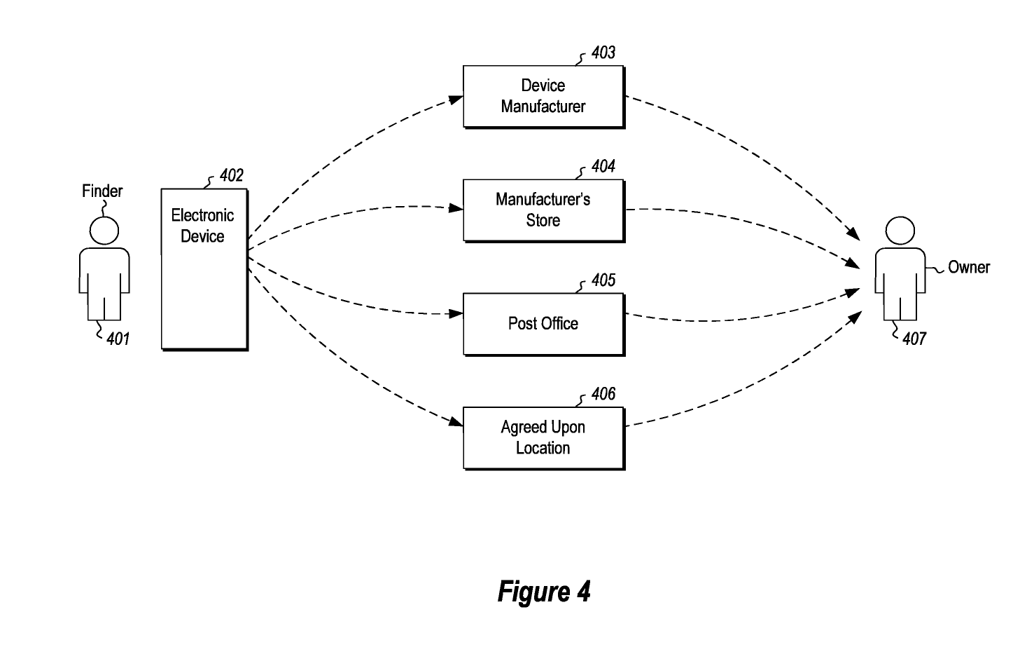

Method 200 next includes sending a notification to the electronic device indicating at least one of a plurality of methods of returning the electronic device to the electronic device's manufacturer (220). In some cases, sending a notification may include retrieving a list of methods for returning the notification 114 to the electronic device. The notification generating module 107 of computer system 101 may generate notification 114 which includes return methods 115 as part of the message. As shown in FIG. 4, the return methods may include sending the electronic device 402 to the device's manufacturer 403, to a device manufacturer's store 404 or other store, to the post office 405 or other store or shipping company so as to ship the device back to the owner 407, to the device manufacturer, or to an agreed upon location 406 which was agreed to by the owner 407 as a place they are comfortable with publicizing to the device's finder 401. It will be understood that many other return methods 115 are also possible, though not shown in FIG. 4.

At this point in the process, the finder of the device 120 may deliver electronic device to an intermediary via one of the available methods of returning device. Indeed, in some embodiments, after the device is sent instructions for return, the next step could either be waiting for the return of the device to the manufacturer and then identifying or notifying the owner, or the next step could be to identifying the owner and notifying them while still waiting for the device to be returned.

Next, upon receiving the electronic device, the owner identifying module 108 of computer system 101 identifies the owner of the electronic device (230). The determining module 109 determines how to provide the electronic device to the identified owner (240), and the providing module 110 provides the electronic device to the identified owner 120 in the determined manner (250). The owner identifying module 108 may look up an identifier associated with the phone (such as a hardware identifier) or may look up a phone's owner based on phone number, or may use other identifiers based on the device type. Lookup by these identifiers may be done through the electronic device recovery service 118. In another embodiment, the owner information may be directly embedded onto the device. Still further, the device may be looked up in the service by hardware ID, user account (e.g. service provider account) that is active for the device, or SIM information (phone number, IMSI, etc). The determining module 109 may use various means to determine that the device is in a lost or stolen state and further determine an appropriate/optimal method of return.

For example, the determining module may determine that the user's electronic device is in a lost or stolen state by determining that incorrect credentials have been provided at least a specified number of times. Still further, the determining module 109 may use a GPS radio and map service to determine where the nearest device manufacturer's store is, or where the nearest post office is, or where a specified location is relative to the finder's current location. Then, based on the location data, the determining module 109 may make an intelligent decision and provide the most convenient return method as the first choice to the finder or possessor.

In some embodiments, the notification 114 sent to the electronic device causes the electronic device 113 to display an address of a nearby store associated with the electronic device. As shown in FIG. 5, the electronic device 501 may display the address of the nearest manufacturer's store 504. In other cases, the notification sent to the electronic device causes the electronic device to provide an address to ship the electronic device to the electronic device's manufacturer, and may further provide an indication of the nearest post office 505 or other shipping store. The notification 114 may cause the electronic device 501 to query a service that provides an indication of which stores are nearby. The service may be a map service or other location information providing service.

In some cases, when identifying a device owner 120, the owner identifying module 108 may look up which user has previously registered for the electronic device. Indeed, when electronic devices are purchased, users may be asked or forced to register their devices before they can be used. During this registration process, users may provide their name, address, phone number, email address and/or other identifying information. This information can then be used if a user ever loses their device or has their device stolen. The owner identifying module 108 can identify the owner associated with a given device using the previously received registration information. Once the owner has been identified, the notification generating module 107 may generate a notification 114 that can be sent to other devices associated with or registered to the user. As such, an electronic device owner 120 may receive a notification on their phone, for example, indicating that their smart watch or laptop has been found. The notification may also indicate how to contact the finder, or may indicate the return status of the device.

In some cases, the notification 114 sent to the electronic device 113 includes customizable content. This customizable content may be provided by the device's owner either at the time of registering the device or at a later point in time. For instance, in some cases, when the true owner is notified that one of their devices has been lost or stolen, the owner may be given a chance at that time to provide the customizable message indicating how they would like the device to be returned to them. In some embodiments, a device owner may be able to specify a customizable amount of money as a reward for the return of the electronic device to either the owner or to the device manufacturer. Accordingly, in such cases, the device's owner may be able to indicate that the finder will receive $50 (or some other customizable amount of money) upon the safe return of the device to its owner. This award amount is displayed on the electronic device as part of the notification 114 sent to the electronic device. The award may be paid through an external service such as a mobile payment service, or may be paid by check or some other payment means. At least in some cases, the reward is paid through an anonymous payment service that does not identify either the owner or the finder directly. As such, the identity and personal information for both the finder and the owner may remain confidential throughout the return process.

In another embodiment, the device manufacturer 116 might provide a reward that they pay for as a good will gesture. This reward may be in addition to the reward provided by the device owner 120. In some cases, this “return reward” may be part of a membership or warranty service sold by the manufacturer or electronic device reseller. The reward may be a physical or digital good, a cash reward, store credit or some other type of incentive for returning the device.

The computer system 101 may be configured to generate analytical data regarding an electronic device successful return rate identifying how many electronic devices are actually returned to their owners. For example, the computer system 101 or the device manufacturer 116 may become aware of a certain number of devices that are reported as lost or stolen by their owners or by law enforcement or by finders of the devices. Of this number of devices reported as missing, the computer system 101 may keep track of the number of devices that are successfully returned to their rightful owners. This analytical data may be used to improve the recovery process over time by identifying potential points of impediment for device finders. For instance, the analytical data may indicate that a high number of devices are found, but very few are actually mailed back to their owners or to the device manufacturer, and on the other hand may find that a high percentage of devices are dropped off at manufacturer's stores. In such cases, the analytical data may be used to change the return instructions (503) so that certain instructions are featured more prominently, as they are more likely to be followed by the device finder. In this manner, the analytical data may examine which return methods are the most successful, and may continually change return instructions accordingly.

Still further, it should be noted that the notification 114 sent by the computer system 101 may be any kind of textual notification such as an email, text message, application push message or the like, or may be an auditory or haptic notification. Such auditory or haptic notifications may work particularly well for electronic devices that have a limited display or no display at all. Such devices may, for example, use vibrations, beeps or other audio signals to notify the finder that the device is lost or stolen and should be returned. Indeed, the notification generating module 107 may generate any type of notification that is appropriate for the displayless or limited-display electronic device.

Turning now to FIG. 3, a flowchart is illustrated of an alternative method 300 for efficiently recovering an electronic device. The method 300 will now be described with frequent reference to the components and data of environment 100.

Method 300 includes determining that the electronic device has been reset (310). Method 300 next includes querying a service such as the electronic device recovery service or a process on the electronic device to determine whether the electronic device has been registered as lost or stolen (320). For example, the query generating module 111 of computer system 101 may generate query 117 which is sent to the electronic device recovery service 118. The query 117 asks the service 118 whether the device 113 has been lost or stolen.

If the electronic device recovery service 118 indicates that the electronic device has been registered as lost or stolen, the providing module 110 of computer system 101 may provide an indication on the electronic device indicating how the electronic device can be returned to the electronic device's manufacturer (330). The indication sent to the electronic device may include many different methods of returning the device including returning the device to the device's manufacturer. In some cases, the electronic device recovery service 118 may be configured to push out notifications to lost or stolen devices automatically upon learning that the device is lost or stolen.

Still further, in some cases, querying the electronic device recovery service 118 to determine whether the electronic device has been registered as lost or stolen may further include determining whether the electronic device has been previously registered to a different user. For instance, if a new user is attempting to register a device that has already been registered, that may indicate to the electronic device recovery service 118 that the device is in someone else's possession and may therefore be lost or stolen. Querying the electronic device recovery service 118 to determine whether the electronic device has been registered as lost or stolen may also be performed upon a device finder providing a unique identifier 121 for the electronic device. The device finder 112 may provide the identifier 121 to the computer system 101 via their own computing device such as a phone, tablet or desktop computing system. For instance, a law enforcement officer may find a phone or have an electronic device returned to them. The officer may use his or her own computing system to provide a serial number or other hardware identifier 121 to the electronic device recovery service 118 which may indicate the current status of the device 119. In some cases, the electronic device 113 itself may be configured to display a unique identifier for the electronic device on the display screen. Thus, for devices that may not have hardware identifiers printed on them (or that are not easy to get to), the device may display a unique identifier associated with the device which allows the device status and/or true owner to be determined.

Upon receiving a returned electronic device, the computer system 101 (which may be owned by the device manufacturer or by another entity) or a service running on the computer system may send a notification to the owner 120 of the electronic device indicating that the electronic device is in the possession of the electronic device's manufacturer, or is in the possession of law enforcement, or is in possession of another user that is attempting to return the device. The user may be able to specify, depending on who the current possessor is (e.g. device manufacturer, law enforcement or other finder) how they want the electronic device to be returned. For instance, if a law enforcement officer is in possession of the device, the user may simply be able to go to the local precinct and pick it up, or may allow the officer to know the owner's personal information. Whereas with an untrusted device finder, the owner may prefer to have the device shipped or otherwise returned to the manufacturer and then back to them.

Claims support: One embodiment includes a computer system that has at least one processor. The computer system performs a computer-implemented method for efficiently recovering an electronic device. The method includes determining that a user's electronic device 113 is in a lost or stolen state, sending a notification 114 to the electronic device indicating at least one of a plurality of methods 115 of returning the electronic device to the electronic device's manufacturer 116, upon receiving the electronic device 113, identifying the owner 120 of the electronic device, determining how to provide the electronic device 113 to the identified owner 120, and providing the electronic device 113 to the identified owner 120 in the determined manner.

Upon receiving the electronic device, the electronic device's manufacturer 116 provides a specified item to the provider of the lost or stolen electronic device. The notification sent to the electronic device causes the electronic device to display an address of a nearby store associated with the electronic device, or to query a service that provides an indication of which stores are nearby. The notification sent to the electronic device causes the electronic device to provide an address to ship the electronic device to the electronic device's manufacturer.

Identifying the owner of the electronic device includes identifying which user has previously registered for the electronic device. Still further, the notification is sent to at least one other device or communication channel registered to the identified user. The notification 114 includes customizable content, allowing the owner to specify how the owner wants the phone to be returned. The electronic device owner also offers a customizable amount of money as a reward for the return of the electronic device to either the owner or to the device manufacturer. Moreover, in at least some embodiments, one or more portions of analytical data are generated regarding an electronic device successful return rate identifying how many electronic devices are actually returned to their owners.

In another embodiment, a computer system is provided which performs a computer-implemented method for efficiently recovering an electronic device. The method includes determining that the electronic device 113 has been reset, querying an electronic device recovery service 118 to determine whether the electronic device has been registered as lost or stolen, and upon determining that the electronic device 113 has been registered as lost or stolen, providing an indication 114 on the electronic device indicating how the electronic device can be returned 115 to the electronic device's manufacturer 116.

Querying an electronic device recovery service to determine whether the electronic device has been registered as lost or stolen further includes determining whether the electronic device has been previously registered to a different user. In some cases, querying an electronic device recovery service to determine whether the electronic device has been registered as lost or stolen is performed upon a user providing a unique identifier for the electronic device. Upon receiving a returned electronic device, a notification is sent to the owner of the electronic device indicating that the electronic device is in the possession of the electronic device's manufacturer.

In another embodiment, a computer system is provided that includes the following: one or more processors, a determining module 109 for determining that a user's electronic device 113 is in a lost or stolen state, a retrieving module for retrieving a list of methods 115 for returning a notification 114 to the electronic device indicating at least one of a plurality of methods of returning the electronic device 113 to the electronic device's manufacturer 116, an owner identifying module 108 that, upon receiving the electronic device, identifies the owner 120 of the electronic device, the determining module 109 determining how to provide the electronic device 113 to the identified owner 120, and a providing module 110 for providing the electronic device 113 to the identified owner 120 in the determined manner. In some cases, determining that the user's electronic device is in a lost or stolen state includes determining that incorrect credentials have been provided at least a specified number of times.

Accordingly, methods, systems and computer program products are provided which efficiently recover an electronic device. In this way, an electronic device can be returned to its owner in a secure manner that avoids exposing the owner's personal information to the finder.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

I claim:

1. At a computer system including at least one processor, a computer-implemented method for efficiently recovering an electronic device, the method comprising:
determining that a user's electronic device is in a lost or stolen state;
sending a notification to the electronic device indicating at least one of a plurality of methods of returning the electronic device to the electronic device's manufacturer;
upon receiving the electronic device, identifying the owner of the electronic device;
determining how to provide the electronic device to the identified owner; and
providing the electronic device to the identified owner in the determined manner.

2. The method of claim 1, wherein upon receiving the electronic device, the electronic device's manufacturer provides a specified item to the provider of the lost or stolen electronic device.

3. The method of claim 1, wherein the notification sent to the electronic device causes the electronic device to display an address of a nearby store associated with the electronic device.

4. The method of claim 3, wherein the notification sent to the electronic device causes the electronic device to query a service that provides an indication of which stores are nearby.

5. The method of claim 1, wherein the notification sent to the electronic device causes the electronic device to provide an address to ship the electronic device to the electronic device's manufacturer.

6. The method of claim 1, wherein identifying the owner of the electronic device includes identifying which user has previously registered for the electronic device.

7. The method of claim 6, further comprising sending the notification to at least one other device or communication channel registered to the identified user.

8. The method of claim 1, wherein the notification includes customizable content, allowing the owner to specify how the owner wants the phone to be returned.

9. The method of claim 1, wherein the electronic device owner offers a customizable amount of money as a reward for the return of the electronic device to either the owner or to the device manufacturer.

10. The method of claim 9, wherein the award amount is displayed on the electronic device as part of the notification sent to the electronic device.

11. The method of claim 1, further comprising generating one or more portions of analytical data regarding an electronic device successful return rate identifying how many electronic devices are actually returned to their owners.

12. At a computer system including at least one processor, a computer-implemented method for efficiently recovering an electronic device, the method comprising:
determining that the electronic device has been reset;
querying an electronic device recovery service to determine whether the electronic device has been registered as lost or stolen; and
upon determining that the electronic device has been registered as lost or stolen, providing an indication on the electronic device indicating how the electronic device can be returned to the electronic device's manufacturer.

13. The method of claim 12, wherein querying an electronic device recovery service to determine whether the electronic device has been registered as lost or stolen further includes determining whether the electronic device has been previously registered to a different user.

14. The method of claim 12, wherein querying an electronic device recovery service to determine whether the electronic device has been registered as lost or stolen is performed upon a user providing a unique identifier for the electronic device.

15. The method of claim 12, wherein the indication provided on the electronic device includes at least one unique identifier for the electronic device.

16. The method of claim 12, further comprising, upon receiving a returned electronic device, sending a notification to the owner of the electronic device indicating that the electronic device is in the possession of the electronic device's manufacturer.

17. The method of claim 16, wherein the user is allowed to select how they want the electronic device to be returned by the manufacturer.

18. A computer system comprising the following:
one or more processors;
one or more computer-readable storage media having stored thereon computer-executable instructions that, when executed by the one or more processors, cause the computing system to perform a method for efficiently recovering an electronic device, the method comprising the following:
determining that a user's electronic device is in a lost or stolen state;
retrieving a list of methods for returning a notification to the electronic device indicating at least one of a plurality of methods of returning the electronic device to the electronic device's manufacturer;
upon receiving the electronic device, identifying the owner of the electronic device;
determining how to provide the electronic device to the identified owner; and
providing the electronic device to the identified owner in the determined manner.

19. The computer system of claim 18, wherein the notification is auditory or haptic, such that the notification is capable of being sent to displayless electronic devices.

20. The computer system of claim 18, wherein determining that the user's electronic device is in a lost or stolen state comprises determining that incorrect credentials have been provided at least a specified number of times.
